(19) United States
(12) Patent Application Publication
(10) Pub. No.: US 2026/0117043 A1
(43) Pub. Date: Apr. 30, 2026

(54) Boron Nitride - Polymer Binder Systems for Protection of Reaction Sensitive Ceramics During Sintering

(71) Applicants: Eugene Napadensky, Newark, DE (US); Kristopher D. Behler, Elkton, MD (US); Randy A. Mrozek, Port Deposit, MD (US); Jerry C. Lasalvia, Belcamp, MD (US)

(72) Inventors: Eugene Napadensky, Newark, DE (US); Kristopher D. Behler, Elkton, MD (US); Randy A. Mrozek, Port Deposit, MD (US); Jerry C. Lasalvia, Belcamp, MD (US)

(21) Appl. No.: 18/783,954

(22) Filed: Jul. 25, 2024

Related U.S. Application Data
(60) Provisional application No. 63/529,520, filed on Jul. 28, 2023.

(51) Int. Cl. C08K 3/38; C08J 3/21; C08J 5/18; C08L 23/22

(52) U.S. Cl. CPC C08K 3/38; C08J 3/212; C08J 5/18; C08L 23/22; C08J 2323/22; C08K 2003/385

(57) ABSTRACT

A boron nitride (BN)-polymer barrier that isolates and protects boron suboxide (nominally, B₆O) and other carbon sensitive ceramic powders during the densification and sintering process is described. The BN-polymer barriers (or “systems”) may include formulations such as free-standing films, appliques (e.g., paints, sprays, coatings, etc.), and solution formulations. Such formulations may be able to be applied to elements such as a graphite mold, die, crucible, and/or graphite paper interlayer. The BN-polymer barrier systems provide superb protection for B₆O ceramic powder from reaction with the carbon originating from graphite molds utilized during sintering, thus reducing the need to machine out and grind large portions of sintered ceramic parts where exposure to carbon transforms B₆O ceramic into undesirable boron carbide (nominally, B₄C). In addition, the polymer binder systems described herein will facilitate the future development of novel ceramic materials previously unavailable due to incompatibility with graphite mold material.

### CROSS-REFERENCE TO RELATED APPLICATIONS

This patent application claims the benefit of U.S. Provisional Patent Application No. 63/529,520 filed on Jul. 28, 2023 which is hereby incorporated by reference herein.

### GOVERNMENT INTEREST

The invention described herein may be manufactured, used and licensed by or for the U.S. Government.

### BACKGROUND OF THE INVENTION

Ceramics and/or metal powders may react with molds used to form various ceramic components. Existing barrier materials may cause inclusions, surface tension issues, and/or may leave residue on the ceramic components. In addition, existing barrier materials may only be available in forms (e.g., pressed inlays) that are difficult to utilize and may not be able to be used with complex and/or differently sized shapes.

Thus, there is a need for a barrier material that will not react with the ceramics and that is able to be utilized in various different forms.

### BRIEF SUMMARY OF THE INVENTION

Some embodiments of the invention may provide a boron nitride (BN)-polymer barrier that isolates and protects boron suboxide (nominally, B₆O) and other carbon sensitive ceramic powders during the densification and sintering process. The BN-polymer barriers (or “systems”) may include formulations such as free-standing films, appliques (e.g., paints, sprays, coatings, etc.), and solution formulations. Such formulations may be able to be applied to elements such as a graphite mold, die, crucible, and/or graphite paper interlayer (or other substrate material). The solution formulations may be applied via brushing, doctor blade, spraying, and/or other appropriate ways, to produce thin layers of robust protective coating. The BN-polymer barrier systems provide superb protection for B₆O ceramic powder from reaction with the carbon originating from graphite molds utilized during sintering, thus reducing the need to machine out and grind large portions of sintered ceramic parts where exposure to carbon transforms B₆O ceramic into undesirable boron carbide (nominally, B₄C). In addition, the polymer binder systems described herein will facilitate the future development of novel ceramic materials previously unavailable to the scientific community due to incompatibility with graphite mold material.

The BN-polymer barrier of some embodiments may provide a protective layer that isolates B₆O and other sensitive (or reactive) ceramic and metal powders from carbon/graphite of the sintering mold during thermal treatments such as hot-pressing, hot-isostatic pressing (HIP), field assisted sintering technologies (FAST), spark plasma sintering (SPS), pressure less sintering, thermal annealing and other high temperature thermal treatments. The BN-polymer barrier prevents carbon from reacting with the powders, for example B₆O reacting with graphite hot-press dies to form B₄C. The BN-polymer barrier may be manufactured by generating a highly loaded BN-polymer binder layer between the B₆O powder (for example) and walls or other surfaces of a graphite mold (and/or other components such as pistons). The barrier may be provided by lining a mold with free standing BN-polymer films in areas where the mold comes in contact with the powder through appliques (via various appropriate application methods) and/or coating those mold surfaces with BN-polymer paint.

The BN-polymer barrier may provide improved durability and ease of handling. In addition, the BN-polymer barrier may reduce costs associated with manufacturing of ceramic components. Current technology to isolate B₆O and other ceramic and metal powders from carbon in graphite molds may include pressed BN ceramic inserts or BN powders. Solid inserts work very well, but they generally survive only one to a few uses and are prohibitively expensive, with price increasing dramatically as diameter of the parts increases. Use of loose (packed) BN powder as an insulating powder layer above and below the B₆O (as well as potentially other metals and ceramics) layer is very cumbersome, extremely difficult to get even (e.g., parallel, flat, and smooth) surfaces, and takes up valuable space inside a mold, thereby reducing production throughput. Further, such an approach does not protect B₆O powder from exposure to the sides of a mold. Thus, expensive machining of the material in contact with the carbon sections is required. There are paints that include BN, but adherence to the graphite surface is abysmal, resulting in flaking and erosion of the protective layer during sample preparation and degradation during handling. The BN-polymer barrier of some embodiments does not suffer from these issues. Materials and processing of BN-polymer binder systems are inexpensive, and the resulting films and appliques are robust enough to be touched and rubbed without falling apart during routine handling. After use, material adhered to the graphite dies and plungers can be easily removed with organic solvents (e.g., tetrahydrofuran, toluene, chloroform, etc.).

The BN-polymer barrier of some embodiments thus allows for formation of B₆O (or other graphite sensitive ceramics and metals) through a hot-press sintering process with less waste and expense due to elimination or minimization of conversion of B₆O ceramic material into B₄C ceramic material and reduce machining time.

The BN-polymer barrier of some embodiments further allows for formation of B₆O (or other graphite sensitive ceramics or metals) through hot-pressing with less waste and expense due to elimination or minimization of conversion of B₆O ceramic material into B₄C ceramic material. Diamond-carbon-silicon carbide composites and diamond-silicon composite materials may also be isolated using the BN-polymer barrier of some embodiments during hot-pressing and field assisted sintering technology (e.g., FAST, SPS, etc.) to prevent unintended reactions.

The BN-polymer barrier of some embodiments may allow formation of B₆O (or other graphite sensitive ceramics and metals) through hot-pressing, field assisted sintering technology (e.g., FAST, SPS, etc.), pressure less sintering, sintering, thermal treatments, and/or thermal annealing with less waste and expense due to elimination or minimization of conversion of B₆O ceramic material into BAC ceramic material.

### BRIEF DESCRIPTION OF DRAWINGS

The novel features of the disclosure are set forth in the appended claims. However, for purposes of explanation, several embodiments are illustrated in the following drawings.

FIG. 1 illustrates a composition table for a BN-polymer material of one or more embodiments described herein;

FIG. 2 illustrates a composition table for a solvent of one or more embodiments described herein;

FIG. 3 illustrates an example overview of one or more embodiments described herein, in which spacers including the barrier material of some embodiments are used during a sintering process;

FIG. 4 illustrates an example overview of one or more embodiments described herein, in which spacers and a wrap including the barrier material of some embodiments are used during a sintering process;

FIG. 5 illustrates an example overview of one or more embodiments described herein, in which a coating including the barrier material of some embodiments is used during a sintering process;

FIG. 6 illustrates a flow chart of an exemplary process that manufactures the barrier material of some embodiments; and

FIG. 7 illustrates a flow chart of an exemplary process that sinters ceramics using the barrier material of some embodiments.

### DETAILED DESCRIPTION OF THE INVENTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a BN-polymer barrier that minimizes or eliminates reaction of carbon with B₆O and other ceramic powders during sintering. The BN-polymer barrier has been utilized to fully densify B₆O ceramic pieces. Reactions with carbon causes conversion of B₆O ceramic powder into B₄C ceramic material during sintering inside graphite molds, which are the source of carbon. To eliminate this conversion, graphite surfaces of the mold may be isolated from B₆O or other ceramic powders by the BN-polymer barrier (also referred to as a “BN-based organic/inorganic system” and “BN polymer binder systems”). Such isolation may be achieved by inserting components such as spacers and/or liners cut from free standing films, by coating graphite surfaces expected to contact the powder with paint or other coating including high levels of BN powder.

It is well known that high levels of particulate loading, like BN, in a polymer system can result in embrittlement and loss of mechanical integrity. As a result, the selection of a polymeric binder is critical for the practical use of the invention. In some embodiments of the BN-polymer barrier, thermoplastic elastomer polymer binders, such as poly(styrene-b-ethylene-co-butylene-b-styrene) (SEBS), enable a composite of BN powder having a concentration of at least forty-five percent of total volume (with the balance being polymer) to remain mechanically robust while also enabling a broad range of application techniques (e.g., melt processing, brush on paints or coatings, spray-paints or coatings, etc.).

The BN-polymer barrier has been tested during sintering of B₆O and has shown a reduction to elimination of formation of B₄C at surfaces protected with the BN-polymer barrier. The BN-polymer barrier of some embodiments provides improved ease of application, reduced costs associated with processing, and flexibility in application method, among other benefits over existing solutions.

Currently, many applications may achieve isolation via powder or pressed powder. Uniform application of powder to the die and molds is difficult and care must be taken to avoid displacement during the die assembly process prior to ceramic part modification. As a result, the texture can be transferred to the part or worse, the material may still react with the mold, risking damage to both the mold and the part. In addition, use of such powders is limited to flat or horizontal surfaces only, and any complex or curved surfaces cannot be isolated using this technique. In some applications, the stand-off between the mold and part can be achieved using BN powder pressed into solid form. These stand-off pieces are typically brittle themselves and break after only one to three uses, thus increasing production cost of the ceramic parts and requiring a large stack pile of inserts of different sizes. The BN-polymer barrier of some embodiments may be embedded into (and/or otherwise adhered to) ready to cut flexible sheets with uniform thickness, painted or spray-coated to form a robust elastomeric coating that will stay in place and intact during the mold assembly process, and/or otherwise be appropriately applied.

Non-uniform coatings of powder lead to risk of damage to the part and the mold both of which can be thousands of dollars in losses for a company in time and productivity. The pressed inserts are expensive. The BN-polymer barrier uses commodity materials and traditional polymer processing methods that are readily scalable.

The BN-polymer barrier may be provided as shelf stable sheets that can be cut to fit at the time of use. The BN-polymer barrier also enables processing of more complicated shapes, where producing a secondary insert or uniformly applying powders may be difficult. The BN-polymer barrier is also more mechanically robust than existing solutions and is more forgiving of incidental bumps or scrapes as the mold is assembled and loaded into the press. The BN-polymer barrier may eliminate and/or minimize the reaction of carbon with B₆O and other ceramic or metal powders during sintering and has been utilized to fully densify B₆O ceramic pieces.

Inserts or inlays are very expensive, are not durable (life span is generally limited to one to a few runs before catastrophic structural failure occurs ruining the inlays), and they are not flexible in use (e.g., a one inch inlay may not be used with a two inch mold) resulting in the need to stockpile a variety of different size inlays or facing work slow-downs waiting for purchase of items of required size. Barriers such as aerosolized BN sprays do not create coating of sufficient thicknesses and robustness to prevent reaction with the carbon or packing powder around the outside of the samples. Commercial BN sprays use a solvent that easily removes the previous thin layer of BN spray, preventing buildup of sufficiently thick protective layer. Use of BN powder around the sample typically results in surface roughness and greater chance of surfaces not being flat or parallel (i.e., further from near-net shape). The BN-polymer barrier addresses all of those issues. Materials to produce BN/SEBS inlays or paint are inexpensive, and extremely flexible (e.g., the same paint can be used to cover molds of various size, and free standing films can be stored in large sheets and cut to desired size immediately prior to use, etc.) thus reducing the need to stockpile various sizes of inserts. Although the BN-polymer barrier may be single use, due to low price and ease of application, the BN-polymer barrier offers significant benefits over existing solutions.

The primary attribute of the BN-polymer barrier is the ability to protect B₆O powder (or other ceramic or metal powders sensitive to carbon) from coming into contact with graphite die, mold, and/or other surfaces during sintering or other thermal processing. In addition, the BN-polymer barrier may promote easier removal of finished ceramic pieces from a mold by acting as a soft solid lubricant on the internal surface of the mold cylinder. The BN-polymer barrier may allow more near net shape manufacturing and may reduce or eliminate the expensive post processing machining typically seen in ceramics. The BN-polymer barrier may extend the lifespan of graphite tooling (e.g., die, mold, pistons, etc.) by decreasing the wear on expensive tooling, a major component of industrial sintering. These films may also be used as protective layers in more geometrically complex systems in which parts are “draped” over mandrels covered with BN films.

Current solutions for protecting B₆O ceramic powder from exposure to carbon in a graphite sintering mold are limited to pressed BN inlays such as thin-walled tubes and flat spacers fitted inside a graphite mold. In contrast, the BN-polymer barrier of some embodiments may be provided in various forms, such as free-standing films, paints, spray coatings, etc. that are able to provide isolation and protection, as well as the ability to conform to complex shapes. Typical ceramic inlays may only be used for specific sizes of dies and/or molds, while the BN-polymer barrier paint of some embodiments may be used to coat mold surfaces of varying size and shape, and free standing BN-polymer barrier films of some embodiments may be stored in large sheets and cut to a desired size (and/or shape) immediately prior to use. The availability of such films eliminates the need to stockpile inlays of various sizes for rapid changes in operational needs. In addition, films may be conformal and able to couple to surfaces of complex geometric molds associated with more complex shapes.

Existing spray or coatings that utilize BN, focus on aerosolizing and applying a thin layer of powder. As a result, the powder is easily displaced or flakes off during handling. In contrast, a BN-polymer barrier spray coating of some embodiments provides a mechanically robust barrier even after one coat, allowing for sequential spraying to build up coating thickness as needed, which is not an option for commercially available spray because a second spray coat damages and flakes off an initial spray coat. The BN-polymer barrier of some embodiments utilizes a combination of organic and inorganic ingredients to provide suitable mechanical performance before the sintering process while still providing a physical barrier during the sintering process. Current state of the art attempts to provide protection utilizing a purely inorganic system, where BN solvents in sprays only function as delivery mechanisms and not present in final coatings. In contrast, the BN-polymer barrier of some embodiments may employ a tri-block copolymer that exhibits reversible crosslinking. The reversible crosslinks may be disrupted using heat (e.g., to manufacture a free-standing film) or solvent (e.g., to manufacture a brushable or sprayable paint or coating) during application while still providing the benefits of a tough cross-linked rubber after the material cools or dries.

The solvents associated with some forms of the BN-polymer barrier of some embodiments (e.g., aerosols, paints, films produced using a doctor blade method, etc.) must be able to dissolve binder, allow for BN powder to remain in suspension for a sufficient period of time required for coating to be applied, be of appropriate viscosity to be useful for selected application process, and provide reasonable drying time (not too long or too short). A solvent including tetrahydrofuran and toluene was shown to facilitate all three application methods tested. Exact concentrations of components may be easily tailored for specific needs, such as lower or higher viscosity, shorter or longer drying times, etc.

A number of techniques based on highly loaded BN-polymer barriers configured to protect boron suboxide, (nominally, B₆O) and other carbon sensitive ceramic powders during thermal processes, densification and sintering have been prepared and tested. The systems include free standing films as thin as one-half millimeter thick, as well as various applique formulations (e.g., paint, spray, aerosol, and slurries) that can be applied directly to a graphite mold or graphite paper interlayer by brushing, doctor blade, or applying an aerosol to produce a thin layer of robust protective coating. The BN-polymer barrier systems may include a polymeric binder (e.g., styrene-ethylene/butylene-styrene block co polymer) highly loaded with BN powder. Such BN-polymer barriers have shown the ability to provide protection for B₆O ceramic powder from chemical reactions between the carbon originating from graphite molds (and/or dies, boats, containers, etc.) utilized during hot-pressing and sintering, thus reducing the need to machine out and polish large portions of sintered ceramic parts where exposure to carbon can transform B₆O ceramic into an undesirable boron carbide (nominally, B₄C) ceramic. The BN-polymer barrier has been applied to other ceramics such as silicon carbide, boron carbide, diamond-based ceramic composites and is applicable to a range of other materials including but not limited to oxides, borides, nitrides and/or sulfides such as calcium sulfide and calcium lanthanum sulfide as well as sub stoichiometric carbides, nitrides and borides. The BN-polymer barrier may provide protection to other types of manufacturing systems. For example, metal systems such as high entropy alloys or metal systems that need to be hot pressed in a graphite die that results in carbide formation may utilize the BN-polymer barrier of some embodiments.

The BN-polymer barrier may provide reduced manufacturing costs (e.g., for ceramic B₆O body armor inserts), may be used as a buffer layer from chemical reaction in processing of ceramics and metals for hypersonic applications (e.g., leading edges, nose cones, transparent windows, etc.), aerospace applications such as thermal protection systems (e.g., thermal barrier coatings), environmental protection systems (e.g., environmental barrier coatings), missile components (e.g., hypersonic leading edges, nose cones, etc.), and may expand the field of use of ceramic materials previously unavailable due to material incompatibility with graphite. The BN-polymer barrier may be utilized in applications such as ceramic manufacturing, automotive parts manufacturing (e.g., for high temperature components), space applications, consumer electronics, polishing implements, ceramic antennas, aerospace applications (e.g., thermal protection systems, thermal barrier coatings, etc.), environmental protection systems and/or environmental barrier coatings), body armor or other protective gear, and/or novel ceramic materials preciously inaccessible for research and manufacture due to incompatibility with graphite molds.

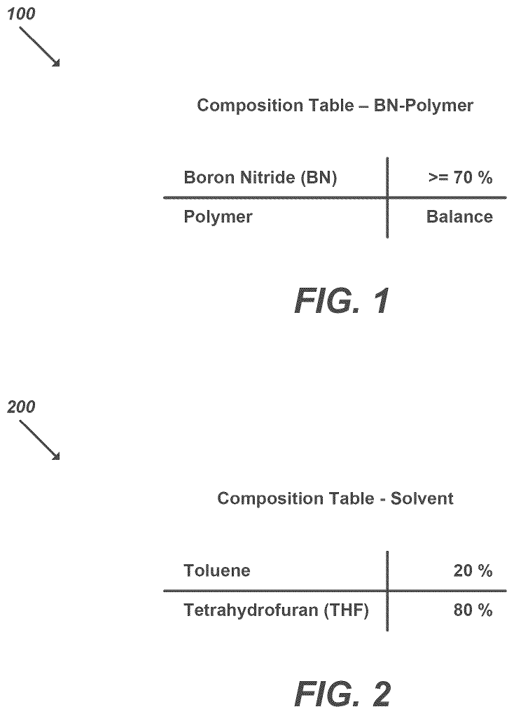

FIG. 1 illustrates a composition table 100 for a BN-polymer material of one or more embodiments described herein. As shown, in this example the BN-polymer composition includes seventy percent (or more) BN and the balance (thirty percent or less) polymer. In this example, percent composition is relative to total weight (e.g., thirty-five grams of BN may be mixed or otherwise combined with fifteen grams of polymer). Different embodiments may have various different compositions. As another example, the BN-polymer composition may include ninety percent (or more) BN and the balance (ten percent or less) polymer, relative to total weight (e.g., forty-five grams of BN may be mixed or otherwise combined with five grams of polymer). Higher loadings of BN (e.g., ninety percent) may require adding solvent The polymer may include materials such as SEBS.

FIG. 2 illustrates a composition table 200 for a solvent of one or more embodiments described herein. As shown, in this example the solvent may include twenty percent toluene and eighty percent tetrahydrofuran (THF). In this example, percent composition is relative to total volume (e.g., twenty milliliters of toluene may be mixed or otherwise combined with eighty milliliters of THF).

A brushable form of the BN-polymer barrier (e.g., a paint) may include, for example, an amount of solvent mixed or otherwise combined with fifty percent (by weight) of the BN-polymer material (conversely, the solvent may be two hundred percent, by weight, of the BN-polymer material). For example, such a form may include twenty milliliters toluene, eighty milliliters THF, five grams SEBS, and forty-five grams BN.

One of ordinary skill in the art will recognize that the compositions indicated above (e.g., the BN-polymer material, the solvent, and combinations of BN-polymer material and solvent), may be implemented in various different ways in different embodiments. For example, the specified amounts of each substance may vary within specified tolerances (e.g., plus/minus one percent, five percent, ten percent, etc.), by equipment resolution and/or accuracy (e.g., plus/minus one milligram, one microgram, etc.), and/or other relevant manufacturing limitations. In addition, the compositions may be varied due to relevant operating attributes or conditions.

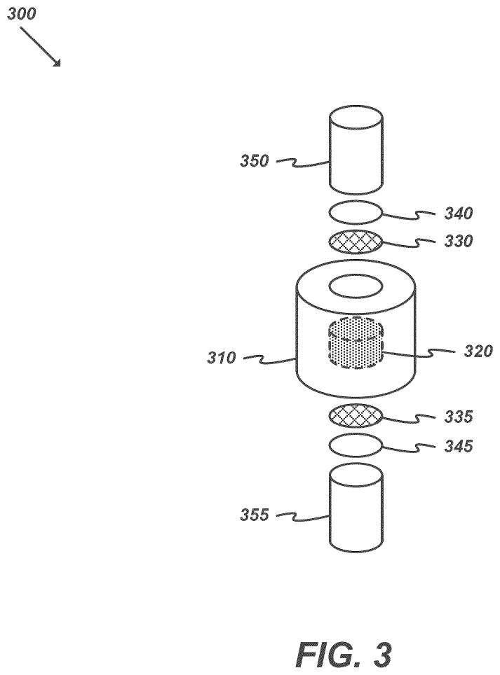

FIG. 3 illustrates an example overview of one or more embodiments described herein, in which spacers including the barrier material of some embodiments are used during a sintering process. As shown, the first example implementation 300 may include a graphite mold 310, ceramic powder 320, BN-polymer barrier spacers 330-335, graphite paper disks 340-345, and graphite piston 350-355.

The graphite mold 310, die, crucible, and/or other appropriate sintering or pressing vessel, may generally include a cavity or void having a complementary shape to a desired shape to article produced using the graphic mold 310. In these examples, the graphite mold 310 (and/or associated elements) may be described by reference to a top/bottom configuration as shown, but one of ordinary skill in the art will recognize that the elements may be arranged in any relative orientation. In addition, although the examples may include two pressing elements, such as graphite pistons 350-355, different embodiments may include different numbers and/or arrangements of such elements, as appropriate for the graphite mold 310 and/or associated cavity shape. For example, some embodiments may include a single “top” pressing element and a mold cavity with a “bottom” surface.

The graphite mold 310 in this example is cylindrical (and has a cylindrical cavity or void), but may have any appropriate shape and/or cavity shape, depending on the attributes of the ceramic parts being produced. Although many examples herein may refer to graphite-based material, one of ordinary skill in the art will recognize that similar techniques, compounds, etc. may be used with various other types of materials (e.g., metals, other carbon-based materials, etc.).

The ceramic powder 320 may include B₆O, other ceramic, and/or metal powders, as appropriate. In this example, the ceramic powder 320 is arranged in a cylindrical shape along a portion of the cavity of graphite mold 310.

Each BN-polymer barrier spacer 330 or 335 may isolate the ceramic powder 320 from the associated graphite paper 340 or 345 and pressing surface of the associated graphite piston 350 or 355. In this example, the BN-polymer barrier spacers 330-335 are round to match the shape of the cavity of graphite mold 310 and the pressing surfaces of graphite pistons 350-355.

When used to protect B₆O during sintering process, BN-polymer barrier spacers 330-335 are placed above and below B₆O or other powders (in the top-to-bottom orientation as shown), and a thin strip of protective material (appropriate for available space) may line the inside of the cylindrical graphite mold 310 (thin strip omitted for clarity).

Each BN-polymer barrier spacer 330 or 335 or may be, include, and/or otherwise utilize a BN-polymer film of some embodiments. In order to manufacture the BN-polymer film, SEBS may be mixed with light mineral oil at one hundred twenty degrees Celsius at a ratio of twenty percent SEBS to thirty percent mineral oil by volume until a clear solution is formed at which point the solution may be cooled and stored for use. The ratio of materials may vary from thirty percent to ten percent by volume of the polymer to reduce the melt viscosity of the SEBS-mineral oil gel prior to BN incorporation while processing at the expense of toughness in the final tape. BN powder may be combined with the SEBS gel and heated to one hundred twenty degrees Celsius to melt the SEBs gel and allow for better and easier mixing.

The BN powder-SEBS gel mixture may be periodically (e.g., every twenty to thirty minutes) removed from the heat source (e.g., an oven) and manually stirred (and/or manipulated using an automated device or system) while hot for five to ten minutes, or until the mixtures cools down to the point that mixing is ineffective. Such mixing may be continued until additional stirring does not seem to improve homogeneity of the mixture, generally after three to five mixing sessions. At that point, the mixing may be refined using a component such as a twin screw extruder. Extruded material may be pressed into one-to two-millimeter-thick sheets in a heated press (even thinner is recommended if planned use of the film is protection of the side of the mold with smaller thickness tolerances as opposed to top/bottom or otherwise arranged pressing surfaces).

After a uniform film is produced, pieces of desired shape and size may be cut from the sheet of film. Next, extraction of the mineral oil may be performed to minimize the quantity of organic matter that may be converted to carbon during the burnout process. Extraction may be performed in any organic solvent that will extract mineral oil without dissolving polymer binder. Isopropanol is suggested, due to low cost and toxicity. The BN-polymer mixture may be placed in an appropriate container or vessel, the container or vessel may be filled with isopropanol and allowed to extract for two to three days (changing solvent four to five times, for example), and then dried. Levels of exaction may be measured gravimetrically. Experiments achieved extraction of greater than ninety-five percent of available mineral oil. The extracted films remain mechanically robust and pliable. The films also do not change consistency after months of storage (or more).

Each graphite paper disk 340 or 345 may have a round shape corresponding to the cylindrical cavity of the graphite mold 310.

Each graphite piston 350 or 355 may have a cylindrical shape with a flat pressing surface in this example. Different embodiments may include differently shaped graphite pistons 350-355, presses, and/or other appropriate components. For example, graphite piston 350 or graphite piston 355 may include a concave or convex pressing surface rather than a flat pressing surface. In addition, although referred to as graphite pistons 350-355, such elements may include various other materials (e.g., metals) in different embodiments. The pistons 350-355 may move along a same axis in opposing directions in some embodiments, as shown.

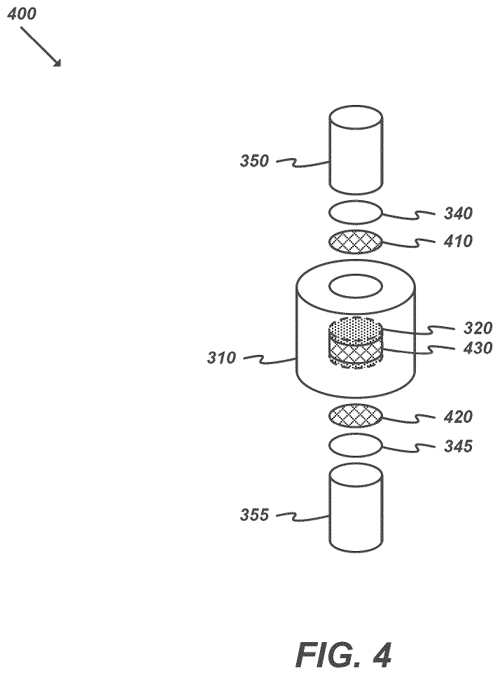

FIG. 4 illustrates an example overview of one or more embodiments described herein, in which spacers and a wrap including the barrier material of some embodiments are used during a sintering process. As shown, the second example implementation 400 may include a graphite mold 310, ceramic powder 320, BN-polymer barrier spacers 410-430, graphite paper disks 340-345, and graphite piston 350-355.

In this example, BN-polymer barrier spacers 410-420 are disks of graphite paper painted with a brushable BN-polymer barrier paint of some embodiments. BN-polymer barrier spacer 430 is a rectangular section of graphite paper painted with the BN-polymer barrier paint arranged to isolate the ceramic powder 320 from the walls of the cavity of graphite mold 310.

The BN-polymer barrier for use with brush as paint applicant may include solvent as indicated by composition table 200 (i.e., twenty percent toluene and eighty percent THF by volume) to which five percent SEBS (and/or other appropriate polymers) and forty-five percent BN by weight may be added (e.g., twenty milliliters toluene, eighty milliliters THF, five grams SEBS, and forty five grams BN may be mixed and/or otherwise combined to generate the brushable paint BN-polymer barrier material).

Mixing and/or otherwise manufacturing such BN-polymer barrier paint may include combining a desired quantity of SEBS with solvent and stirring the mixture in a closed container until the SEBS is completely dissolved. BN powder may be added to the mixture and stirred, mixed, generally agitated, and/or otherwise manipulated until a uniform solution is obtained. Such an approach will produce an emulsion with BN particles remaining suspended for several hours. Particles may need to be re-suspended through thorough mixing and agitation prior to use.

Direct painting may be performed with a standard paint brush on pre-cut pieces of graphite paper that were to be used as top and bottom spacers (e.g., spacers such as spacers 340-345), as well as a strip of carbon paper to serve as BN-polymer barrier spacer 430. Painted parts may be air dried for a specified period of time (e.g., one hour), then placed into vacuum oven at forty-five degrees Celsius for another specified period of time (e.g., one hour) to remove residual solvent prior to use.

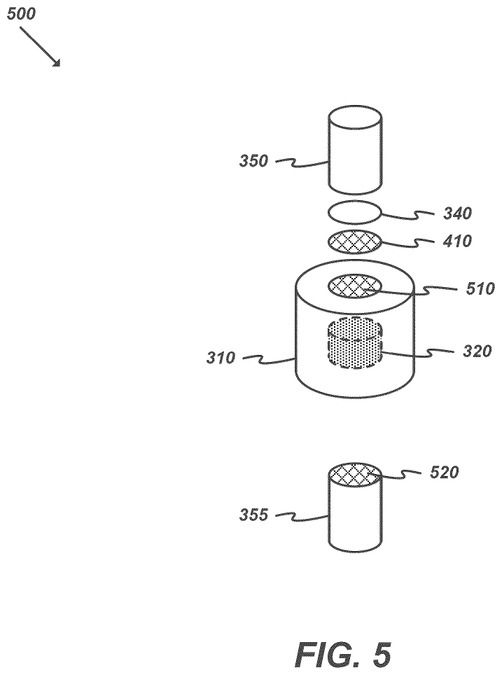

FIG. 5 illustrates an example overview of one or more embodiments described herein, in which a coating including the barrier material of some embodiments is used during a sintering process. As shown, the third example implementation 500 may include a graphite mold 310, ceramic powder 320, a BN-polymer barrier spacer 410, a graphite paper disk 340, and graphite piston 350-355. lin this example, an interior surface 510 of the graphite mold 310 and a pressing surface 520 of the graphite piston 355 have been coated with BN-polymer barrier sprayable paint.

To achieve good coverage with a spray gun or air brush, the sprayable paint formulation may include relatively more solvent than the brushable paint. For example, a formulation including solvent (e.g., twenty percent toluene and eighty percent THF by volume) combined with two-and-one-half percent SEBS and twenty-two-and-one-half percent BN by weight performs well (conversely, the solvent may be four hundred percent, by weight, of the BN-polymer material).

To mix such a sprayable paint, a desired quantity of SEBS may be combined with solvent in a closed container and stirred, mixed, or otherwise agitated until completely dissolved. BN powder may be added to the mixture and stirred, mixed, generally agitated, and/or otherwise manipulated until a uniform solution is obtained. Spray-painting may be performed using various appropriate tools, settings, etc. For example, using an air pressure of fifteen psi to achieve paint thicknesses of one hundred fifty micrometers thick may produce a nine-to-one BN to SEBS ratio by weight.

Using spray consumes a larger quantity of paint than brushing, However, spray painting may be used to cover large areas and complex shapes with a uniform layer of coating. Thus, it is possible to paint inside cavity of a graphite mold 310 (for example) and large swatches of graphite paper.

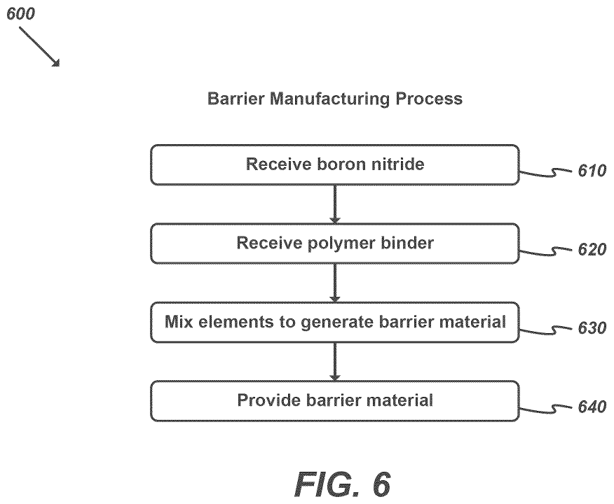

FIG. 6 illustrates an example process 600 for manufacturing the barrier material of some embodiments. Such a process may be used to generate BN-polymer barrier material having various different form factors associated with various different application methods.

As shown, process 600 may include receiving (at 610) boron nitride.

Process 600 may include receiving (at 620) polymer binder material. SEBS may be mixed with light mineral oil at one hundred twenty degrees Celsius at a ratio of twenty percent SEBS to thirty percent mineral oil by volume until a clear solution is formed at which point the solution may be cooled and stored for use.

The process may include mixing (at 630) the received elements to generate the barrier material of some embodiments. The ratio of materials may vary from thirty percent to ten percent by volume of the polymer to reduce the melt viscosity of the SEBS-mineral oil gel prior to BN incorporation while processing at the expense of toughness in the final tape. BN powder may be combined with the SEBS gel and heated to one hundred twenty degrees Celsius to melt the SEBs gel and allow for better and easier mixing. The BN powder-SEBS gel mixture may be periodically (e.g., every twenty to thirty minutes) removed from the heat source (e.g., an oven) and manually stirred (and/or manipulated using an automated device or system) while hot for five to ten minutes, or until the mixtures cools down to the point that mixing is ineffective. Such mixing may be continued until additional stirring does not seem to improve homogeneity of the mixture, generally after three to five mixing sessions. As described above, different ratios of solvent to BN-polymer material may be used to achieve various different form factors (e.g., brushable paint, sprayable paint, powders, etc.).

As shown, process 600 may include providing (at 640) the barrier material. Such provision may include various different operations depending on the desired form of the barrier material (e.g., film, brushable paint, spray paint, etc.).

For example, to generate a BN-polymer barrier film, the mixing may be refined using a component such as a twin screw extruder. Extruded material may be pressed into one-to two-millimeter-thick sheets in a heated press. After a uniform film is produced, pieces of desired shape and size may be cut from the sheet of film. Next, extraction of the mineral oil may be performed to minimize the quantity of organic matter that may be converted to carbon during the burnout process. Extraction may be performed in any organic solvent that will extract mineral oil without dissolving polymer binder. Isopropanol is suggested, due to low cost and toxicity. The BN-polymer mixture may be placed in an appropriate container or vessel, the container or vessel may be filled with isopropanol and allowed to extract for two to three days (changing solvent four to five times, for example), and then dried.

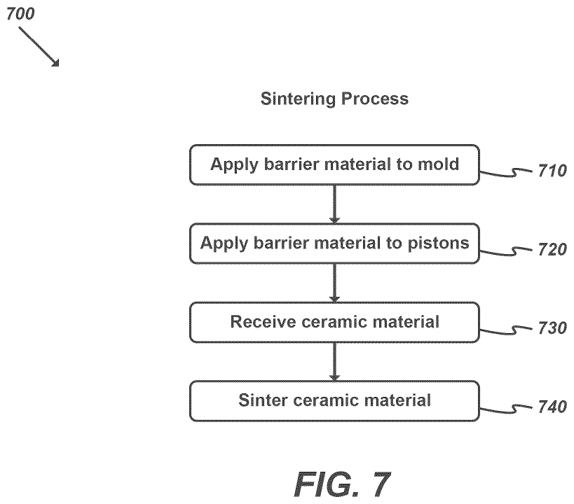

FIG. 7 illustrates an example process 700 for sintering ceramics using the barrier material of some embodiments. The process may be used to manufacture ceramics, such as B₆O ceramic powder while isolating the powder from a mold or similar apparatus.

As shown, process 700 may include applying (at 710) the barrier material of some embodiments to a mold, such as graphite mold 310. As described above, such application may include, for example, provision of BN-polymer barrier spacers (e.g., BN-polymer barrier spacers 330-335 or 410-430), application of BN-polymer paint to one or more surfaces of the graphite mold 310 (e.g., surface 510), and/or other appropriate ways of applying the BN-polymer barrier material.

Process 700 may include applying (at 720) the barrier material to a set of pistons associated with the mold. For example, BN-polymer paint may be applied surface 520 of graphite piston 355).

The process may include receiving (at 730) ceramic material. For instance, ceramic powder may be used to fill at least a portion of the mold cavity or void.

As shown, process 700 may include sintering (at 740) the ceramic material. Such sintering may include, for example, pressing the ceramic powder into the mold or die and then heating the pressed powder at low temperature to burn off the binder material.

One of ordinary skill in the art will recognize that processes 600 and 700 may be implemented in various different ways without departing from the scope of the disclosure. For instance, the elements may be implemented in a different order than shown. As another example, some embodiments may include additional elements or omit various listed elements. Elements or sets of elements may be performed iteratively and/or based on satisfaction of some performance criteria. Non-dependent elements may be performed in parallel. Elements or sets of elements may be performed continuously and/or at regular intervals.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

1. A boron nitride (BN)-polymer barrier, comprising:
at least seventy percent BN by weight; and
a polymer binder.

2. The BN-polymer barrier of claim 1, wherein the polymer binder comprises poly(styrene-b-ethylene-co-butylene-b-styrene) (SEBS).

3. The BN-polymer barrier of claim 2 further comprising mineral oil.

4. The BN-polymer barrier of claim 2 further comprising a solvent.

5. The BN-polymer barrier of claim 4, wherein the solvent comprises twenty percent toluene and eighty percent tetrahydrofuran.

6. The BN-polymer barrier of claim 5, wherein the solvent is two hundred percent to four hundred percent, by weight, of the BN and the polymer binder.

7. A method of manufacturing a boron nitride (BN)-polymer barrier, the method comprising:
combining a polymer binder and a solvent in a closed container;
agitating the polymer binder and the solvent;
adding BN powder to the polymer binder and the solvent; and
agitating the BN powder, polymer binder, and the solvent.

8. The method of claim 7, wherein the polymer binder comprises poly(styrene-b-ethylene-co-butylene-b-styrene) (SEBS).

9. The method of claim 8, wherein the polymer binder comprises mineral oil.

10. The method of claim 7, wherein the solvent comprises twenty percent toluene and eighty percent tetrahydrofuran.

11. The method of claim 7, wherein the ratio, by weight, of the BN powder to the polymer binder is seven to three.

12. The method of claim 7 further comprising:
extruding the polymer binder, the BN powder, and the solvent; and
pressing the extruded polymer binder, BN powder, and solvent into a sheet.

13. The method of claim 7, wherein the BN powder comprises thirty-five percent, by weight, of the solvent and the polymer binder comprises fifteen percent, by weight, of the solvent.

14. The method of claim 7, wherein the BN powder comprises twenty-two-and-one-half percent, by weight, of the solvent and the polymer binder comprises two-and-one-half percent, by weight, of the solvent.

15. A boron nitride (BN)-polymer barrier, comprising:
BN powder;
a polymer binder; and
a solvent.

16. The BN-polymer barrier of claim 15, wherein the polymer binder comprises poly(styrene-b-ethylene-co-butylene-b-styrene) (SEBS).

17. The BN-polymer barrier of claim 16, wherein the polymer binder comprises mineral oil.

18. The BN-polymer barrier of claim 15, wherein the BN powder comprises thirty-five percent, by weight, of the solvent and the polymer binder comprises fifteen percent, by weight, of the solvent.

19. The BN-polymer barrier of claim 15, wherein the BN powder comprises twenty-two-and-one-half percent, by weight, of the solvent and the polymer binder comprises two-and-one-half percent, by weight, of the solvent.

20. The BN-polymer barrier of claim 15 further comprising a graphite paper substrate.
